(19) United States
(12) Patent Application Publication
(10) Pub. No.: US 2025/0144833 A1
(43) Pub. Date: May 8, 2025

(54) DRUM DICING ASSEMBLY AND DICER

(71) Applicant: Changzhou Mr Wheat electric appliance Co., Ltd., Changzhou City (CN)

(72) Inventors: Yufeng QIAN, Changzhou City (CN); Fei CHEN, Changzhou City (CN)

(21) Appl. No.: 18/903,279

(22) Filed: Oct. 1, 2024

(30) Foreign Application Priority Data
Nov. 3, 2023 (CN) 202322972352.0

(51) Int. Cl. B26D 3/22

(52) U.S. Cl. CPC B26D 3/22

(57) ABSTRACT

The disclosure discloses a drum dicing assembly and a dicer, wherein the dicing assembly includes a cutting cylinder, a slicing knife cylinder and a dicing knife cylinder, the slicing knife cylinder is rotatably provided in the cutting cylinder, a slicing knife and a material pressing rib are provided on a cylinder wall of the slicing knife cylinder, the dicing knife cylinder is sheathed in the slicing knife cylinder, a dicing knife net on the cylinder wall of the dicing knife cylinder is formed by cross-combining several first dicing knives and several second dicing knives, and the knife edge portion of the first dicing knife and the knife edge portion of the second dicing knife have a height difference, so that the dicing action of food materials is completed by dividing into three steps of slicing, stripping and dicing.

### TECHNICAL FIELD

The disclosure relates to a food material processing tool, and more particularly, to a drum dicing assembly and a dicer.

### BACKGROUND ART

Common processing forms of food materials mainly include slicing, shredding, milling and dicing, etc. According to different needs of food materials processing, there are also some different types of vegetable cutter. Different from slicing, shredding and milling, dicing generally requires at least two steps to be completed. At present, there are mainly two ways of slicing-dicing and shredding-dicing, and the way of first slicing and then dicing is more common in a knife disc type vegetable cutter, for example, “a food processor dicing assembly and a food processor having the same” disclosed in Chinese Patent No. ZL201320590577.3, which uses a cutting knife to firstly cut a food material into pieces and then presses same into a knife net to form dices; the way of first shredding and then dicing is also used in a drum vegetable cutter, for example, “a manual drum vegetable and fruit dicer” disclosed in Chinese Patent No. ZL201920155797.0, wherein a dicing cylinder fixed on a cutting cylinder body is sheathed on the inner side of a shredding cylinder, and the food material is first cut into silk by the shredding cylinder and then pressed into a dicing knife blade to form dices.

Both of the above-mentioned two schemes can achieve food material dicing, but the practical application shows that the dicing action is mainly completed by extrusion, and the extrusion resistance of dicing is larger, and in addition to the resistance generated by slicing or shredding, it is laborious to operate the manual-driven vegetable cutter, which seriously affects the practicality and user experience of the dicer; the need for a more powerful motor drive for an electrically driven vegetable cutter increases product cost.

Therefore, how to reduce the resistance of the dicing process becomes one of the difficult problems of the above-mentioned dicer, and it is also an urgent problem to be solved.

### SUMMARY OF THE INVENTION

### 1. Technical Problem to be Solved

The object of the disclosure is to overcome the disadvantages of the existing dicer, such as high dicing resistance, and to provide a drum dicing assembly and a dicer. With the technical solution of the disclosure, the first dicing knife and the second dicing knife of the dicing knife cylinder have a height difference, so that the dicing action of the food material is completed by dividing into three steps of slicing, stripping and dicing. After the food material is sliced by the slicing knife cylinder, the food material is extruded by a material pressing rib and firstly cut into strips by a group of dicing knives, and then cut into dices by another group of dicing knives, so that the extrusion resistance generated by the extrusion dicing is reduced, so that the whole dicing action is more easy and labor-saving.

### 2. Technical Scheme

In order to achieve the above object, the disclosure provides the following technical solutions:

A drum dicing assembly of the disclosure includes,
a cutting cylinder, wherein a feeding cylinder is provided on a cylinder wall of the cutting cylinder; and
a slicing knife cylinder, wherein the slicing knife cylinder is rotatably provided in the cutting cylinder, a slicing knife is provided on a cylinder wall of the slicing knife cylinder, and a material pressing rib is provided on an inner cylinder wall of the slicing knife cylinder; and
a dicing knife cylinder, wherein the dicing knife cylinder is sheathed in the slicing knife cylinder, and the dicing knife cylinder is fixedly connected to the cutting cylinder, a dicing knife net opposite to the feeding cylinder is provided on the cylinder wall of the dicing knife cylinder, and
a lower port of the feeding cylinder is located within the range of an effective net surface of the dicing knife net, and the dicing knife net is formed by cross-combining several first dicing knives and several second dicing knives, the knife edge portion of the dicing knives and the knife edge portion of the second dicing knives have a height difference.

Furthermore, the first dicing knife is an arc-shaped knife blade provided along the circumference of the dicing knife cylinder, the second dicing knife is a straight knife blade provided along the generatrix of the dicing knife cylinder, the knife edge portion of the first dicing knife is higher than the knife edge portion of the second dicing knife, and the first dicing knife and second dicing knife are both perpendicular to the cutting plane of the slicing knife cylinder located directly below the feeding cylinder.

Furthermore, the dicing knife cylinder has a cylinder body, the dicing knife net is provided on the cylinder body, and a front end of the cylinder body is detachably connected to the cylinder opening of the cutting cylinder.

Furthermore, the front end of the cylinder body of the dicing knife cylinder is provided with a lock catch, the cylinder opening of the cutting cylinder is provided with a clasp at a position corresponding to the above-mentioned lock catch, and the dicing knife cylinder is detachably fixed together with the clasp on the cutting cylinder by the lock catch.

Furthermore, the lock catch comprises a push button, a locking piece and an elastic piece, the locking piece is movably installed at the front end of the cylinder body, the push button is connected to the locking piece, the elastic piece is provided between the cylinder body and the locking piece, so that the locking piece has an elastic tendency to snap together with the clasp, the front end of the cylinder is further provided with an abutment portion which abuts against the clasp.

Furthermore, the dicing knife net is a knife net assembly detachably installed on the cylinder body.

Furthermore, the shape of a single mesh on the dicing knife net is square or rectangular, and the length of a single side of the single mesh is 6 mm to 32 mm.

Furthermore, a lower part of the slicing knife is provided with a pre-pressing inclined plane along the cutting direction, the material pressing rib is provided with 1 to 6 strips at intervals on the inner cylinder wall of the slicing knife cylinder, a material pressing height of the material pressing rib adjacent to the pre-pressing inclined plane is greater than the material pressing height of the pre-pressing inclined plane, and when two or more material pressing ribs are provided, the material pressing height of each material pressing rib gradually increases from the slicing knife backwards along the rotation direction of the slicing knife cylinder.

Furthermore, the lower part of the slicing knife is provided with a pre-pressing inclined plane along the cutting direction, the material pressing height of the material pressing rib is greater than the material pressing height of the pre-pressing inclined plane, and the material pressing rib is closely fitted with an outer side wall of the cylinder body of the dicing knife cylinder.

Furthermore, the material pressing rib is a spiral rib spirally provided along the rotation direction of the slicing knife cylinder towards the front discharge port.

Furthermore, the inside of the slicing knife cylinder is axially provided with a discharger extending into the dicing knife cylinder.

Furthermore, the discharger includes a cone and several wing plates provided on an outer sidewall of the cone.

Furthermore, the slicing knife cylinder comprises a knife cylinder holder, a slicing knife group and a material pressing plate, wherein the slicing knife group and the material pressing plate are respectively detachably installed on the knife cylinder holder, the slicing knife is provided on the slicing knife group, and the material pressing rib is provided on the inner side of the material pressing plate.

The disclosure relates to a dicer, including a base, and further including the above-mentioned drum dicing assembly, wherein the cutting cylinder is fixed on the base, the rear end of the slicing knife cylinder is drivingly connected to a driving mechanism, and a material presser is further provided in the feeding cylinder.

### 3. Advantageous Effects

With the technical solution provided by the disclosure, the following advantageous effects are obtained:
(1) The dicing assembly includes a cutting cylinder, a slicing knife cylinder and a dicing knife cylinder, the slicing knife cylinder is rotatably provided in the cutting cylinder, a slicing knife and a material pressing rib are provided on a cylinder wall of the slicing knife cylinder, the dicing knife cylinder is sheathed in the slicing knife cylinder, a dicing knife net on the cylinder wall of the dicing knife cylinder is formed by cross-combining several first dicing knives and several second dicing knives, and the knife edge portion of the first dicing knife and the knife edge portion of the second dicing knife have a height difference, so that the dicing action of food materials is completed by dividing into three steps of slicing, stripping and dicing, and the slicing, stripping and dicing actions are completed sequentially in sequence. After the food material is sliced by the slicing knife cylinder, the food material is extruded by a material pressing rib and firstly cut into strips by a group of dicing knives, and then cut into dices by another group of dicing knives, so that the extrusion resistance generated by the extrusion dicing is reduced, so that the whole dicing action is more easy and labor-saving; for a manually driven dicer, the operation is more labor-saving, and the user experience is better; for an electrically driven dicer, the required motor power is less, and the product cost and working energy consumption are reduced.
(2) The first dicing knife is an arc-shaped knife blade provided along the circumference of the dicing knife cylinder, the second dicing knife is a straight knife blade provided along the generatrix of the dicing knife cylinder, the knife edge portion of the first dicing knife is higher than the knife edge portion of the second dicing knife, the arc-shaped knife blade and the straight knife blade are snap-fitted and connected together via opposite slots, the formed dicing knife net has high overall strength, the knife blade are not easily deformed after being subjected to a force, and the dicing action is more stable; the first dicing knife and the second dicing knife are perpendicular to the cutting plane of the slicing knife cylinder located directly below the feeding cylinder, so that the dicing knife and the food material slice can be cut in a certain vertical state, so that the dicing is more smooth and the quality of the cut food material dice is good.
(3) The dicing knife cylinder has a cylinder body, a dicing knife net is provided on the cylinder body, a front end of the cylinder body is detachably connected to a cylinder opening of the cutting cylinder, so as to facilitate the disassembly, replacement and cleaning of the dicing knife cylinder, and different dicing knife cylinders can be selected according to the size of dicing.
(4) The dicing knife cylinder and the cutting cylinder are connected by a lock catch structure, and the installation and disassembly of the dicing knife cylinder are achieved by locking or unlocking the lock catch, and the operation is simple and convenient, and the dicing knife cylinder is firmly and stably installed; furthermore, the lock catch includes a push button, a locking piece and an elastic piece, the front end of the cylinder body is further provided with an abutment portion abutting against the clasp, the push button is used to facilitate the unlocking operation of the lock catch, the elastic piece can maintain the locking stability of the locking piece and the clasp, the abutment portion can form a positioning function with the clasp, the structure design is simple and compact, and the disassembly and assembly operation of the dicing knife cylinder is convenient.
(5) The dicing knife net is a knife net assembly, and the knife net assembly is detachably installed on the cylinder body, so that dicing knife nets with different dicing sizes can be replaced according to needs, which satisfies different food material processing needs of consumers and is more practical; furthermore, the shape of a single mesh on the dicing knife net is square or rectangular, and the length of a single edge of the single mesh is 6 mm to 32 mm; by means of a reasonable mesh setting, the problem that the dicing resistance is too large to be used normally is effectively avoided, and the dicing resistance is effectively reduced.
(6) The lower part of the slicing knife is provided with a pre-pressing inclined plane along the cutting direction, and the pre-pressing inclined plane is used to press the cut-off food material against the dicing knife net while the slicing action of the slicing knife is performed, so as to have a preliminary fixing and cutting function on the food material, and prevent the cut-off slice-shaped food material from rotating together with the slicing knife cylinder; the material pressing ribs are provided with 1 to 6 strips at intervals on the inner cylinder wall of the slicing knife cylinder, the material pressing height of the material pressing ribs adjacent to the pre-pressing inclined plane is greater than the material pressing height of the pre-pressing inclined plane, and when two or more material pressing ribs are provided, the material pressing height of each material pressing rib gradually increases from the slicing knife to the rear along the rotation direction of the slicing knife cylinder, so that food material slices with a certain thickness can be pressed down several times, further reducing the dicing resistance.
(7) The lower part of the slicing knife is provided with a pre-pressing inclined plane along the cutting direction, the material pressing height of the material pressing rib is greater than the material pressing height of the pre-pressing inclined plane, and the material pressing rib is closely fitted with the outer side wall of the cylinder body of the dicing knife cylinder, which can effectively ensure the coaxiality of the cutting cylinder, the slicing knife cylinder and the dicing knife cylinder, and the slicing knife cylinder can play a certain supporting role on the dicing knife cylinder, further facilitating the extrusion of the food material slice into the food material dice.
(8) The material pressing rib is a spiral rib spirally provided along the rotation direction of the slicing knife cylinder towards the front discharge port, and the spiral rib can also perform gradual and gradual extrusion on the food material slice, so that the dicing action is smoother and the dicing resistance is further reduced.
(9) The inside of the slicing knife cylinder is axially provided with a discharger extending into the dicing knife cylinder, and the discharger can rotate together with the slicing knife cylinder, facilitating rapid stripping and discharging of the food material dice in the dicing knife cylinder, and improving the food material discharging speed.
(10) The discharger includes a cone and several wing plates provided on the outer side wall of the cone, wherein the cone can guide the food material dice toward the discharge port, and the wing plates can toggle the food material dice to accelerate the discharge of the food material.
(11) The slicing knife cylinder includes a knife cylinder holder, a slicing knife group and a material pressing plate, wherein the slicing knife group and the material pressing plate are respectively detachably installed on the knife cylinder holder, so as to facilitate the replacement of different slicing knives and material pressing ribs, and the processing of food material dices of different sizes can be realized with different dicing knife cylinders or knife net assemblies.
(12) A dicer according to the disclosure uses the above-mentioned drum dicing assembly, so that the dicing of dicer can be cut more easily and quickly, and the efficiency of dicing food material is greatly improved.

### BRIEF DESCRIPTION OF THE DRAWINGS

FIG. 1 is a schematic view showing a disassembled structure of a drum dicing assembly of Embodiment 1 of the disclosure;

FIG. 2 is a schematic view showing an overall structure of the drum dicing assembly of Embodiment 1 of the disclosure;

FIG. 3 is a schematic axial cross-sectional view showing a structure of the drum dicing assembly of FIG. 2;

FIG. 4 is a schematic view showing a structure of a vegetable cutting drum in the drum dicing assembly of Embodiment 1;

FIG. 5 is a schematic view showing an overall structure of the slicing knife cylinder in the drum dicing assembly of Embodiment 1;

FIG. 6 is a schematic radial cross-sectional view showing a structure of the slicing knife cylinder of FIG. 5;

FIG. 7 is a schematic view showing an angle disassembled structure of the slicing knife cylinder in the drum dicing assembly of Embodiment 1;

FIG. 8 is a schematic view showing another angle disassembled structure of the slicing knife cylinder in the drum dicing assembly of Embodiment 1;

FIG. 9 is a schematic view showing a structure of a material pressing plate in the slicing knife cylinder of Embodiment 1;

FIG. 10 is a schematic view showing a structure of a dicing knife cylinder in the drum dicing assembly of Embodiment 1;

FIG. 11 is a schematic axial cross-sectional view showing the dicing knife cylinder of FIG. 10;

FIG. 12 is a schematic view showing a disassembled structure of a dicer of Embodiment 1 of the disclosure;

FIG. 13 is a schematic view showing an overall structure of a dicer of Embodiment 1 of the disclosure;

FIG. 14 is a schematic view showing a disassembled structure of a drum dicing assembly of Embodiment 2 of the disclosure;

FIG. 15 is a schematic view showing an overall structure of the drum dicing assembly of Embodiment 2 of the disclosure;

FIG. 16 is a schematic axial cross-sectional view showing a structure of the drum dicing assembly of FIG. 15;

FIG. 17 is a partially enlarged structural view at K of FIG. 16;

FIG. 18 is a schematic view showing a structure of a dicing knife cylinder in the drum dicing assembly of Embodiment 2;

FIG. 19 is a schematic view showing a detachable structure of the dicing knife cylinder of Embodiment 2;

FIG. 20 is a schematic view showing a disassembled structure of a dicer of Embodiment 2 of the disclosure; and

FIG. 21 is a schematic view showing an overall structure of a dicer of Embodiment 2 of the disclosure.

### DESCRIPTION OF REFERENCE NUMERALS

1. cutting cylinder; 1-1. feeding cylinder; 1-2. rotary snap; 1-3. clasp;
2. slicing knife cylinder; 2A. knife cylinder holder; 2B. slicing knife group; 2C. material pressing plate; 2-1. slicing knife; 2-1a. pre-pressing inclined plane; 2-2. material pressing rib; 2-3. discharger; 2-3a. cone; 2-3b. wing plate; 2-4. drive shaft; 2-5. clamping groove; 2-6. snap; 2-7. tongue;
3. dicing knife cylinder; 3-1. cylinder body; 3-1-1. abutment portion; 3-2. dicing knife net; 3-2a. first dicing knife; 3-2b. second dicing knife; 3-3. cylinder cover; 3-4. rotary snap groove; 3-5. lock catch; 3-5-1. push button; 3-5-2. locking piece; 3-5-3. elastic piece;
4. material presser; 5. base; 5-1. hand crank.

### DETAILED DESCRIPTION OF THE INVENTION

To further understand the content of the present invention, a detailed description of the present invention will be provided in conjunction with the drawings and embodiments.

### Embodiment 1

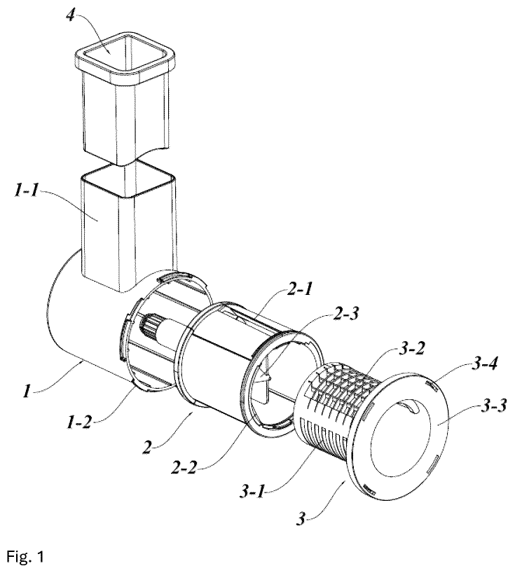

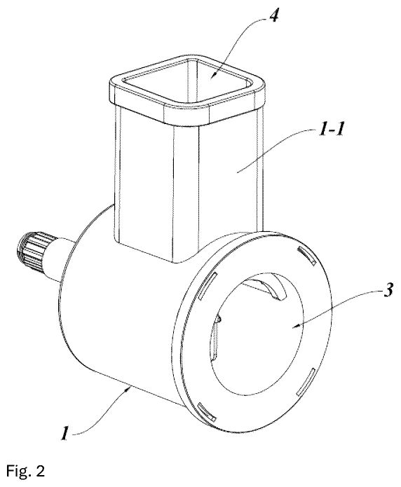

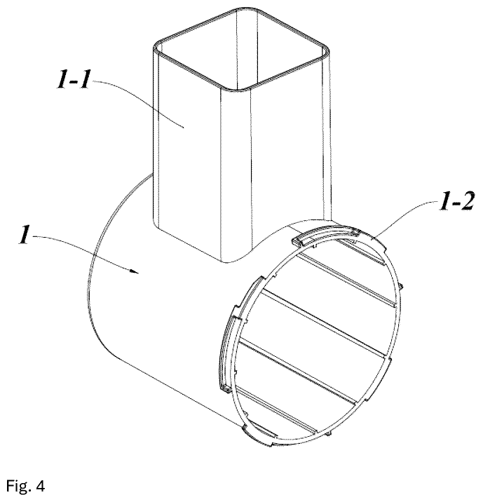

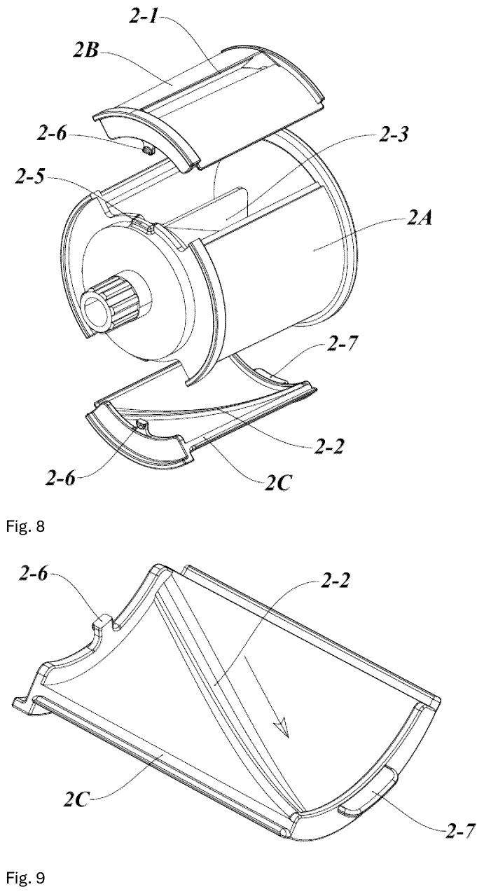

With reference to FIGS. 1-11, a drum dicing assembly of the embodiment includes a cutting cylinder 1, a slicing knife cylinder 2 and a dicing knife cylinder 3, wherein a feeding cylinder 1-1 is provided on the cylinder wall of the cutting cylinder 1, the feeding cylinder 1-1 is in communication with the cylinder body of the cutting cylinder 1, and food materials are fed from the feeding cylinder 1-1; the slicing knife cylinder 2 is rotatably provided in the cutting cylinder 1, and can freely rotate in the cutting cylinder 1; a slicing knife 2-1 is provided on the cylinder wall of the slicing knife cylinder 2; the food material in the feeding cylinder 1-1 is cut into slices by using the rotation of the slicing knife 2-1; a material pressing rib 2-2 is provided on the inner cylinder wall of the slicing knife cylinder 2; the material pressing rib 2-2 rotates with the slicing knife cylinder 2 to press the cut food material slices; the dicing knife cylinder 3 is sheathed in the slicing knife cylinder 2, and the dicing knife cylinder 3 is fixedly connected to the cutting cylinder 1; the dicing knife cylinder 3 does not rotate itself; a dicing knife net 3-2 is provided on the cylinder wall of the dicing knife cylinder 3 at a position opposite to the feeding cylinder 1-1, and the lower port of the feeding cylinder 1-1 is located within the range of the effective net surface of the dicing knife net 3-2; the dicing knife net 3-2 is in a grid shape; the material pressing rib 2-2 presses the slice-shaped food material towards the dicing knife net 3-2, cuts through the dicing knife net 3-2 to form a dice-shaped food material, and discharges same from the inner side of the dicing knife cylinder 3. By “effective net surface range” of the dicing knife net 3-2 is meant the grid range in which a slice cut by the slicing knife cylinder 2 can be completely diced and discharged by the dicing knife net 3-2, that is, the size of the dicing knife net 3-2 is larger than the size of the lower port of the feeding cylinder 1-1, and the lower port of the feeding cylinder 1-1 is completely covered by the dicing knife net 3-2. The dicing knife net 3-2 is formed by cross-combining several first dicing knives 3-2a and several second dicing knives 3-2b, wherein the first dicing knives 3-2a and the second dicing knives 3-2b can be provided perpendicular to each other, and can also be provided at an included angle of a certain non −90°, so as to form grid holes of a certain shape and size, and the size and shape of the grid holes determine the size and shape of the food material dices; the knife edge portion of the first dicing knife 3-2a and the knife edge portion of the second dicing knife 3-2b have a height difference, and the slice-shaped food material is always cut into strips (not completely separated) by one group of dicing knives, and then cut into small blocks by another group of dicing knives. In this way, the dividing action of the food material is completed by dividing into three steps of slicing, stripping and dicing, and the slicing, stripping and dicing actions are completed sequentially in sequence; after the food material is sliced by the slicing knife cylinder 2, the food material is extruded by a material pressing rib 2-2 and firstly cut into strips by a group of dicing knives, and then cut into dices by another group of dicing knives, so that the extrusion resistance generated by the extrusion dicing is reduced, so that the whole dicing action is more easy and labor-saving; for a manually driven dicer, the operation is more labor-saving, and the user experience is better; for an electrically driven dicer, the required motor power is less, and the product cost and working energy consumption are reduced.

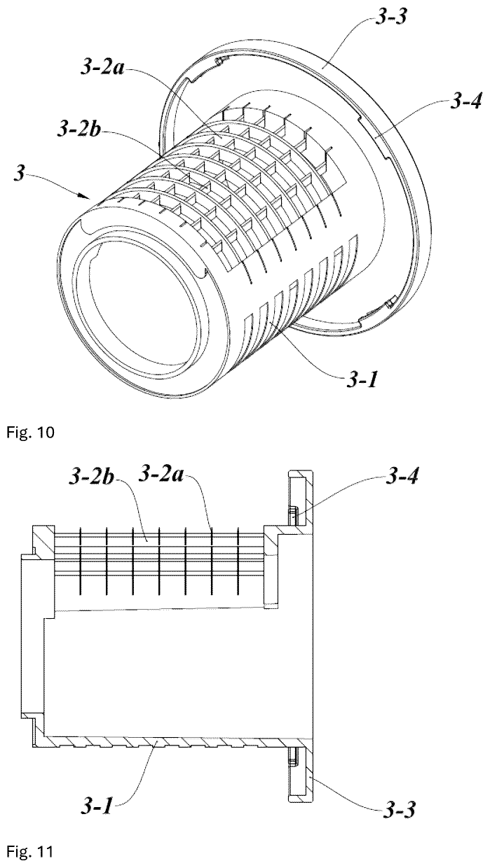

As shown in FIGS. 10 and 11, in the embodiment, the first dicing knife 3-2a is an arc-shaped knife blade provided along the circumference of the dicing knife cylinder 3, the second dicing knife 3-2b is a straight knife blade provided along the generatrix of the dicing knife cylinder 3, and the first dicing knife 3-2a and the second dicing knife 3-2b are perpendicular to each other; specifically, both the first dicing knife 3-2a and the second dicing knife 3-2b are provided with opposite slots, and the arc-shaped knife blade and the straight knife blade are snap-fitted and connected together via opposite slots, so that the formed dicing knife net has a high overall strength, and the knife blades are not easily deformed after being subjected to a force, and the diving action is more stable. As one of the embodiments, the knife edge portion of the first dicing knife 3-2a is higher than the knife edge portion of the second dicing knife 3-2b, and the food material can be gradually cut along the knife edge of the arc-shaped knife blade by first stripping with the arc-shaped knife blade, so that cutting is more smooth and labor-saving. Furthermore, the first dicing knife 3-2a and the second dicing knife 3-2b are perpendicular to the cutting plane of the slicing knife cylinder 2 directly below the feeding cylinder 1-1. In general, the feeding direction of the feeding cylinder 1-1 is also perpendicular to the cutting plane of the slicing knife cylinder 2 which is located directly below the feeding cylinder 1-1, so that the food material can be better pressed against the outer cylinder wall of the slicing knife cylinder 2, facilitating the cutting of the food material by the slicing knife 2-1; in this way, the feeding direction of the feeding cylinder 1-1 is basically consistent with the orientation of the knife edge portions of the first dicing knife 3-2a and the second dicing knife 3-2b, so that the dicing knife and the food material slice can be kept in a certain vertical state for cutting, so that the cutting is more smooth and the quality of the cut food material dice is good. In addition, the shape of a single mesh on the dicing knife net 3-2 is square or rectangular, and the length of a single side of the single mesh is 6 mm to 32 mm, and the shape and size of the mesh can be determined according to the specific arrangement of the first dicing knife 3-2a and the second dicing knife 3-2b. The results show that when the length of the single side of the single mesh is less than 6 mm, the dicing resistance increases sharply, which makes the cutting operation difficult to be carried out normally. However, when the size of the single side is larger than 32 mm, the formed food material dice is basically a square piece with four sides cut, which basically has no essential difference with the food material slice cut by the common vegetable cutter, so the significance of dicing is lost. For this reason, through the above-mentioned reasonable mesh size setting, the problem that the dicing resistance is too large to be used normally is effectively avoided, and the dicing resistance is effectively reduced.

The first dicing knife 3-2a and the second dicing knife 3-2b described above can be injection-molded with the main body portion of the dicing knife cylinder 3 as an integral structure having high strength. Furthermore, the dicing knife cylinder 3 has a cylinder body 3-1, the cylinder body 3-1 is generally cylindrical, a dicing knife net 3-2 is provided on the cylinder body 3-1, a cylinder opening of the cutting cylinder 1 at the front end of the cylinder body 3-1 is detachably connected, so as to facilitate the disassembly, replacement and cleaning of the dicing knife cylinder 3, and different specifications of the dicing knife cylinder 3 can be selected according to the size of the dicing, and different dicing knife cylinders 3 can be replaced as a whole. Specifically, the front end of the cylinder body 3-1 is provided with a cylinder cover 3-3, the inner side of the cylinder cover 3-3 is provided with a rotary snap groove 3-4, in particular implementation, a flange structure provided backwards can be provided on the outer side of the cylinder cover 3-3, the rotary snap groove 3-4 is formed on the inner side wall of the flange, the outer side of the cylinder opening of the cutting cylinder 1 is provided with a rotary snap 1-2, and the cylinder cover 3-3 and the cutting cylinder 1 are rotationally snap-connected via the rotary snap groove 3-4 and the rotary snap 1-2. Of course, a rotary snap groove structure can also be provided outside the cylinder opening of the cutting cylinder 1, and a rotary snap structure can also be provided on the cylinder cover 3-3, and the rotary snap connection between the cylinder cover 3-3 and the cutting cylinder 1 can also be realized. With the above-mentioned detachable structure, the structure is simple, and the disassembly and assembly operations are simple and convenient. It should be understood that the dicing knife cylinder 3 and the cutting cylinder 1 in the disclosure are not limited to the above-mentioned rotary snap connection, and the two may also be used in an existing detachable connection such as a threaded connection.

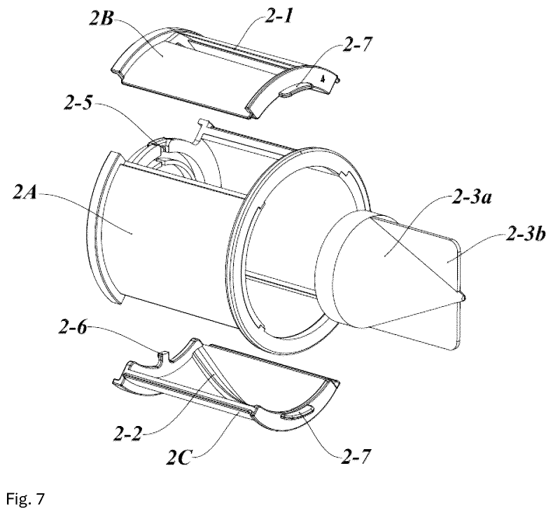

With reference to FIG. 6, in the embodiment, the lower part of the slicing knife 2-1 is provided with a pre-pressing inclined plane 2-1a along the cutting direction, the pre-pressing inclined plane 2-1a is an inclined plane provided along the slicing knife 2-1, and the food material slice cut by the slicing knife 2-1 is guided and pressed downwards by the pre-pressing inclined plane 2-1a, so that the food material is pressed towards the dicing knife net 3-2, so as to perform a preliminary fixing and cutting function on the food material, and prevent the cut food material slice from rotating together with the slicing knife cylinder 2. The material pressing rib 2-2 is provided with 1 to 6 strips at intervals on the inner cylinder wall of the slicing knife cylinder 2, and the material pressing height of the material pressing rib 2-2 is greater than the material pressing height of the pre-pressing inclined plane 2-1a; FIGS. 6 and 7 show an embodiment provided with one strip of the material pressing rib 2-2; the food material pressed into the dicing knife net 3-2 via the pre-pressing inclined plane 2-1a is further pressed via the material pressing rib 2-2, so that the food material is completely pressed into the dicing knife net 3-2; and as the cutting continues, the food material on the dicing knife net 3-2 is further pressed to form a dice-shaped food material into the inside of the cylinder body 3-1 of the dicing knife cylinder 3. When two or more material pressing ribs 2-2 are provided, the material pressing height of the material pressing rib 2-2 adjacent to the pre-pressing inclined plane 2-1a is greater than the material pressing height of the pre-pressing inclined plane 2-1a, the material pressing height of each material pressing rib 2-2 gradually increases from the slicing knife 2-1 to the rear along the rotation direction of the slicing knife cylinder 2, and the last material pressing rib 2-2 can fit closely with the outer side wall of the cylinder body 3-1 of the dicing knife cylinder 3. In order to facilitate understanding, the state shown in FIG. 6 is explained, the slicing knife cylinder 2 rotates in a counterclockwise direction in FIG. 6, and the material pressing height of each material pressing rib 2-2 in a clockwise direction starting from the slicing knife 2-1 gradually increases, so that the food material slice cut from the slicing knife 2-1 successively passes through the gradual pressing of the pre-pressing inclined plane 2-la and each material pressing rib 2-2 enables the food material slice of a certain thickness to be pressed several times, further reducing the dicing resistance. With reference to FIG. 9, as a preferred solution, the material pressing rib 2-2 is a spiral rib spirally provided along the rotation direction of the slicing knife cylinder 2 towards the front discharge port, that is to say, the material pressing rib 2-2 is spirally provided inclined in the direction of the “arrow” in FIG. 9 with respect to the slicing knife cylinder 2, and with the rotation of the slicing knife cylinder 2, the material pressing rib 2-2 near the rear of the slicing knife cylinder 2 contacts the food material slice firstly, and the material pressing rib 2-2 near the front discharge port of the slicing knife cylinder 2 contacts the food material slice afterward, which can also gradually and gradually squeeze the food material slice, so that the dicing action is more smooth, and the dicing resistance is further reduced.

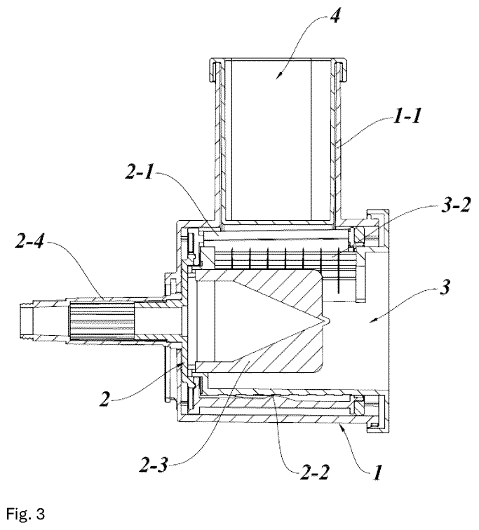

In order to facilitate the rapid discharge of the food material, referring to FIGS. 3 and 7, in the embodiment, the inside of the slicing knife cylinder 2 is axially provided with a discharger 2-3 extending into the dicing knife cylinder 3, the discharger 2-3 can be directly welded and fixed together with the slicing knife cylinder 2, or can be assembled and fixed to the slicing knife cylinder 2, and the discharger 2-3 can rotate together with the slicing knife cylinder 2, facilitating the rapid stripping and discharge of the food material dice in the dicing knife cylinder 3, and increasing the food material discharge speed. The discharger 2-3 may take a different structural form, having a through hole at the rear of the dicing knife cylinder 3 through which the discharger 2-3 passes. Specifically, in the embodiment, as shown in FIG. 7, the discharger 2-3 includes a cone 2-3a and several wing plates 2-3b provided on the outer side wall of the cone 2-3a, wherein the wing plates 2-3b can adopt a flat plate-shaped or arc-shaped structure, for example, two symmetrically provided flat plate-shaped wing plates shown in FIG. 7, and the conical tip of the cone 2-3a faces the discharge port and can play a guiding function to guide the food material dice towards the discharge port, and the wing plates 2-3b can toggle the food material dice to speed up the discharge of the food material.

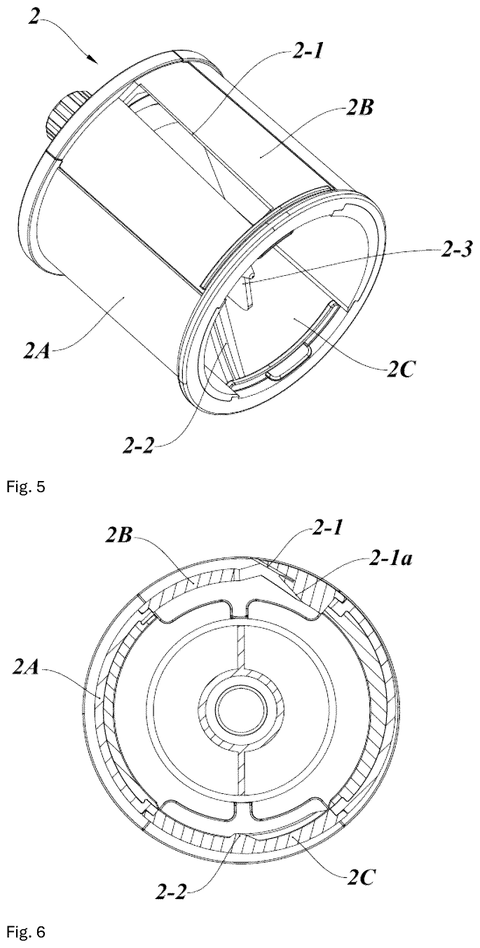

The above-mentioned slicing knife 2-1 and the material pressing rib 2-2 may be integrally provided on the slicing knife cylinder 2. In order to facilitate the replacement of different slicing knives 2-1 and material pressing ribs 2-2, a detachable assembly structure may also be used. With reference to FIGS. 5 to 9, the slicing knife cylinder 2 includes a knife cylinder holder 2A, a slicing knife group 2B and a material pressing plate 2C, wherein the slicing knife group 2B and the material pressing plate 2C are respectively detachably installed on the knife cylinder holder 2A, the slicing knife 2-1 is provided on the slicing knife group 2B, and the material pressing rib 2-2 is provided on the inner side of the material pressing plate 2C. By adopting this structure design, it is convenient to replace different slicing knife 2-1 and material pressing rib 2-2, and to realize the processing of different sizes of food material dice with different dicing knife cylinder 3. In order to facilitate installation and disassembly, an installation cavity can be provided on the cylinder wall of the knife cylinder holder 2A, a clamping groove 2-5 can be provided at the rear of the corresponding installation cavity of the knife cylinder holder 2A, a snap 2-6 can be provided at the rear of the slicing knife group 2B and the material pressing plate 2C, a tongue 2-7 can be provided at the front of the slicing knife group 2B and the material pressing plate 2C, one end of the tongue 2-7 is inserted into the front end of the corresponding installation cavity during installation, and one end of the snap 2-6 is snapped inwards into the corresponding clamping groove 2-5 to realize the installation of the slicing knife group 2B and the material pressing plate 2C on the knife cylinder holder 2A. During disassembly, only the tail parts of the slicing knife group 2B and the material pressing plate 2C need to be buckled to separate the snaps 2-6 from the clamping grooves 2-5, which facilitates the disassembly and replacement of the slicing knife 2-1 and the material pressing rib 2-2.

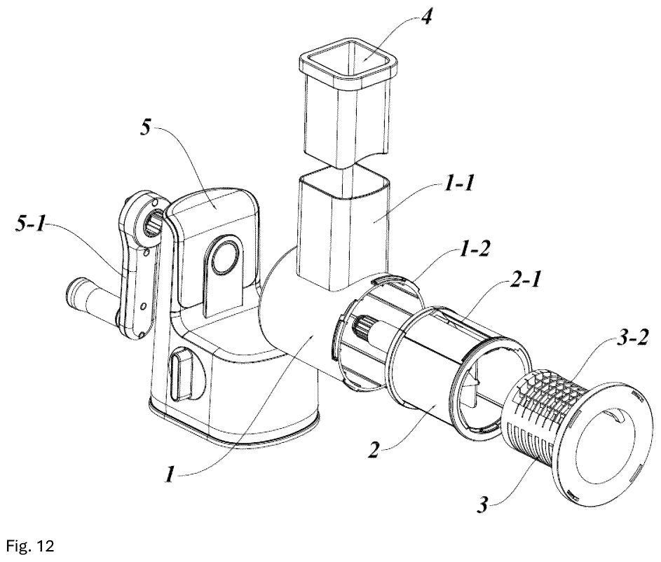

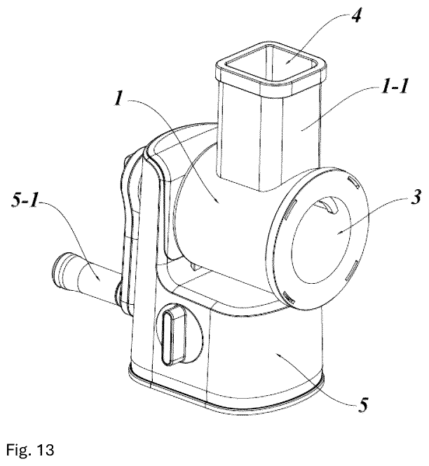

As shown in FIGS. 12 and 13, this embodiment also discloses a dicer. The dicer includes a base 5 and the above-mentioned drum dicing assembly, wherein the cutting cylinder 1 is fixed on the base 5, the rear end of the slicing knife cylinder 2 is drivingly connected to the driving mechanism, and a material presser 4 is further provided in the feeding cylinder 1-1. In use, the food material is put into the feeding cylinder 1-1, the slicing knife cylinder 2 is driven to rotate by a driving mechanism, and the food material is pressed down by a hand or a material presser 4, the lower part of the food material is cut into a slice by the slicing knife 2-1 on the slicing knife cylinder 2, and then enters the dicing knife net 3-2 of the internal dicing knife cylinder 3 through the extrusion of the internal structure of the slicing knife cylinder 2, and is cut into the food material dice.

The above-mentioned driving mechanism can be a manual driving mechanism or an electric driving mechanism, and the manual driving mechanism can be mainly a hand crank 5-1; the rear part of the slicing knife cylinder 2 is connected to the hand crank 5-1 via a drive shaft 2-4, and the slicing knife cylinder 2 is driven to rotate by rotating the hand crank 5-1; the electric driving mechanism may be a motor and a driving mechanism thereof installed inside the base 5, and the motor and the driving mechanism thereof are used to drive the rotary motion of the slicing knife cylinder 2. Both the manual driving mechanism and the electric driving mechanism described above are prior art and will not be described further herein. The cutting cylinder 1 can be directly fixed as one body with the base 5, or can be detachably installed on the base 5 in a separate body. The installing method of the cutting cylinder 1 and the base 5 is also similar to the prior art, and the description thereof will not be repeated here.

### Embodiment 2

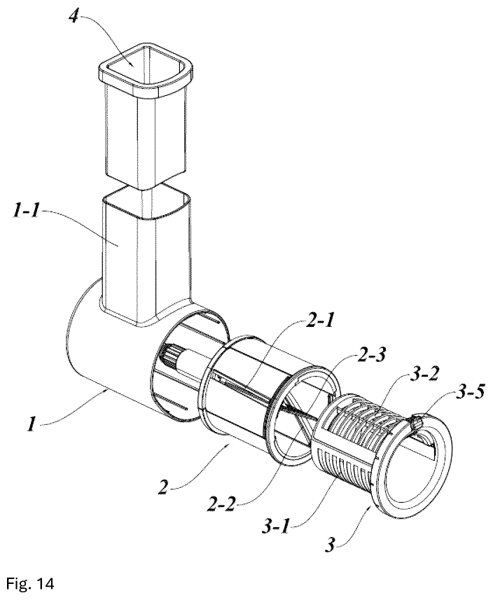

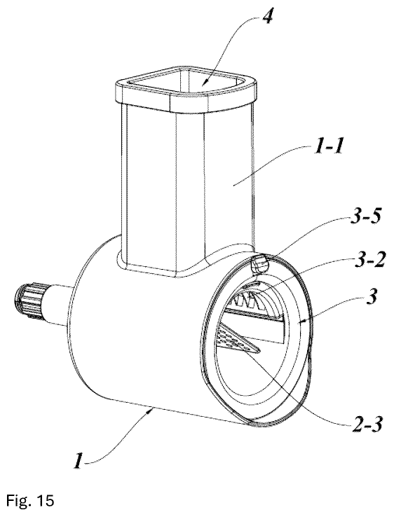

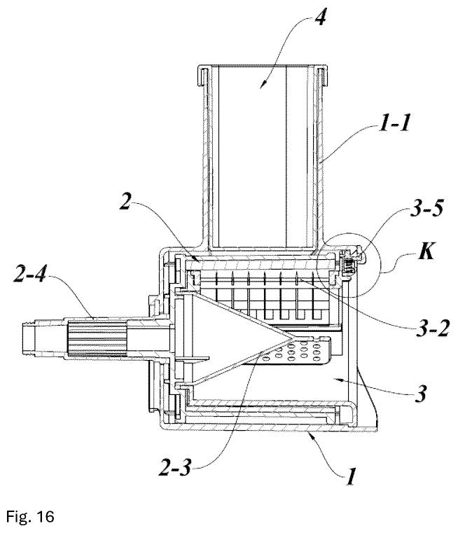

FIGS. 14 to 21 show another embodiment of the disclosure. As shown in the drawings, a drum dicing assembly and a dicer according to this embodiment have the same basic structure and operation principle as those of Embodiment 1, except that:
in the embodiment, a lock catch structure is used to connect the dicing knife cylinder 3 and the cutting cylinder 1. As shown in FIGS. 14 to 18, a lock catch 3-5 is provided at the front end of the cylinder body 3-1 of the dicing knife cylinder 3, a clasp 1-3 corresponding to the above-mentioned lock catch 3-5 is provided at the cylinder opening of the cutting cylinder 1, and the dicing knife cylinder 3 is detachably fixed together with the clasp 1-3 on the cutting cylinder 1 via the lock catch 3-5. The installation and disassembly of the dicing knife cylinder 3 by locking or unlocking the lock catch 3-5, which is simple and convenient to operate, and the dicing knife cylinder 3 is firmly and stably installed.

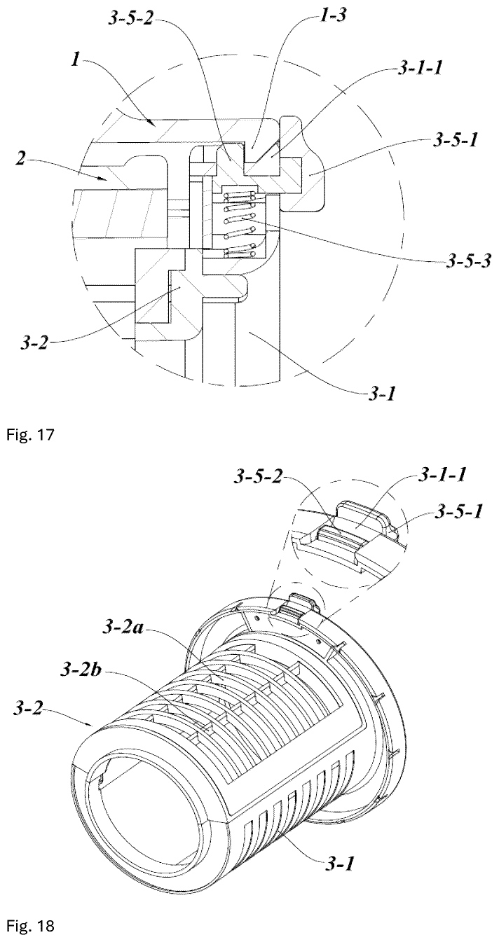

With particular reference to FIG. 17, the above-mentioned lock catch 3-5 includes a push button 3-5-1, a locking piece 3-5-2 and an elastic piece 3-5-3, wherein the locking piece 3-5-2 is movably installed at the front end of the cylinder body 3-1, the push button 3-5-1 is connected to the locking piece 3-5-2, and the push button 3-5-1 is located outside the cylinder body 3-1 so as to facilitate an unlocking operation; the elastic piece 3-5-3 is provided between the cylinder body 3-1 and the locking piece 3-5-2, so that the locking piece 3-5-2 has an elastic tendency to snap together with the clasp 1-3, and the front end of the cylinder body 3-1 is further provided with an abutment portion 3-1-1 abutting against the clasp 1-3. The clasp 1-3 is preferably provided on the inner side wall of the front end of the cutting cylinder 1, and the locking piece 3-5-2 maintains an elastic extension tendency in a radial direction under the action of the elastic piece 3-5-3, and the elastic piece 3-5-3 may use a compression spring. In order to facilitate installation, a guide slope may be provided at the front of the clasp 1-3, and when the dicing knife cylinder 3 is installed, the locking piece 3-5-2 contacts before the guide slope of the clasp 1-3, and the guide slope applies a radial component force to the locking piece 3-5-2, so that the locking piece 3-5-2 is compressed downwards, and after the clasp 1-3 passes over the locking piece 3-5-2, the locking piece 3-5-2 automatically pops out under the action of the elastic piece 3-5-3 and locks with the clasp 1-3. The abutment portion 3-1-1 also has an abutment surface cooperating with the guide slope to ensure stability of the connection. When unlocking, the locking piece 3-5-2 is separated from the clasp 1-3 only by pushing the locking piece 3-5-2 with the push button 3-5-1. Adopting the above-mentioned lock catch 3-5 design, using the push button 3-5-1 to facilitate the unlocking operation of the lock catch, using the elastic piece 3-5-3 to maintain the locking stability of the locking piece 3-5-2 and the clasp 1-3, using the abutment portion 3-1-1 to form a positioning function with the clasp 1-3, the structure design being simple and compact, and the disassembly and assembly operation of the dicing knife cylinder 3 being convenient.

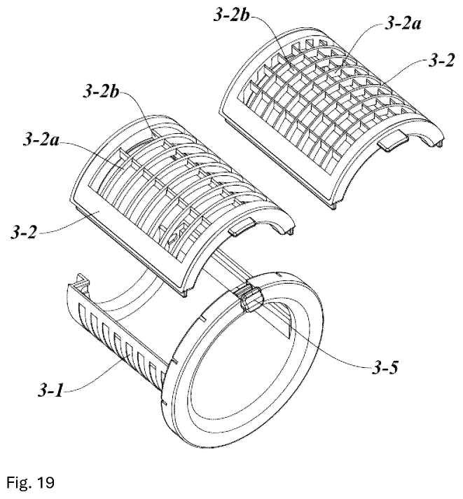

With reference to FIG. 19, in the embodiment, the dicing knife net 3-2 is a knife net assembly which is detachably installed on the cylinder body 3-1, and the dicing knife net 3-2 with different dicing sizes can be replaced according to needs, so as to satisfy different food material processing needs of consumers, and is more practical. Two different shapes and sizes of the dicing knife net 3-2 are shown in FIG. 19, for example a rectangular mesh of 9 mm×21 mm on the left and a square mesh of 9 mm×9 mm on the right in FIG. 19. The connection structure between the knife net assembly and the cylinder body 3-1 may adopt a connection structure similar to that of the above-mentioned slicing knife group 2B and the material pressing plate 2C on the knife cylinder holder 2A, which will not be described again.

In addition, unlike Embodiment 1, in this embodiment, the lower part of the slicing knife 2-1 is provided with a pre-pressing inclined plane 2-1a along the cutting direction, the material pressing height of the material pressing rib 2-2 is greater than the material pressing height of the pre-pressing inclined plane 2-1a, and the material pressing rib 2-2 is closely fitted with the outer side wall of the cylinder body 3-1 of the dicing knife cylinder 3, which can effectively ensure the coaxiality of the cutting cylinder 1, the slicing knife cylinder 2 and the dicing knife cylinder 3, and the slicing knife cylinder 2 can play a certain supporting role on the dicing knife cylinder 3, further facilitating the extrusion of the food material slice into the food material dice.

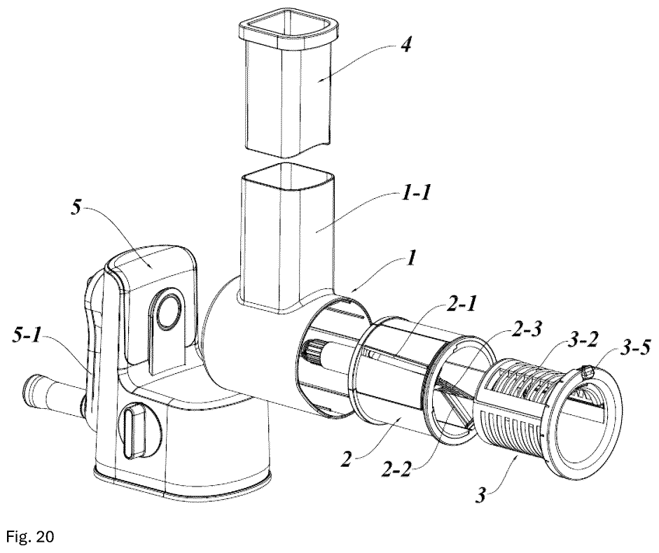

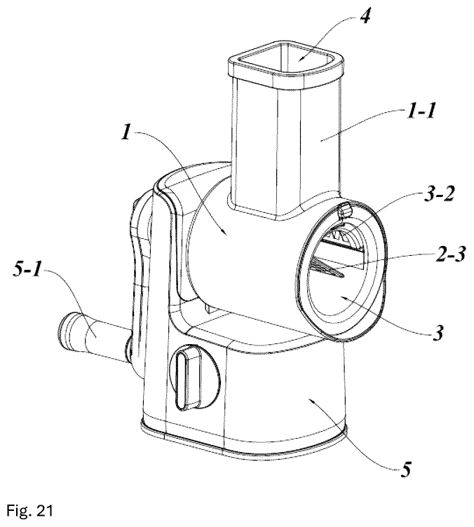

FIGS. 20 and 21 show a dicer of the embodiment. The dicer includes the above-mentioned drum dicing assembly, and the structure and operating principle of the dicer are the same as those in Embodiment 1, except for the differences between the above-mentioned drum dicing assembly.

A drum dicing assembly and a dicer of the disclosure, wherein the dicing action of the food materials is completed by dividing into three steps of slicing, stripping and dicing, and the food materials are sliced by a slicing knife cylinder and then extruded by a material pressing rib to be firstly cut into strips by a group of dicing knives and then cut into dices by another group of dicing knives, so that the extrusion resistance generated by the extrusion dicing is reduced, so that the whole dicing action is more easy and labor-saving; for a manually driven dicer, the operation is more labor-saving, and the user experience is better; for an electrically driven dicer, the required motor power is less, and the product cost and working energy consumption are reduced; through the structural design of the material pressing rib, the food material slice with a certain thickness can be pressed down several times, further reducing the dicing resistance; by providing a discharger inside the dicing knife cylinder which rotates with the slicing knife cylinder, the food material dices in the dicing knife cylinder can be quickly peeled off and discharged, and the food material discharging speed can be increased.

The disclosure and its embodiments have been described above schematically without limitation, and the drawings show only one of the embodiments of the disclosure, and the actual structure is not limited thereto. Therefore, if those skilled in the art are inspired by the teachings of the disclosure, structural modes and embodiments similar to those of the disclosure can be devised without inventive step without departing from the spirit of the disclosure all should fall within the scope of the disclosure.

1. A drum dicing assembly, comprising
a cutting cylinder (1), wherein a feeding cylinder (1-1) is provided on a cylinder wall of the cutting cylinder (1); and
a slicing knife cylinder (2), wherein the slicing knife cylinder (2) is rotatably provided in the cutting cylinder (1), a slicing knife (2-1) is provided on a cylinder wall of the slicing knife cylinder (2), and a material pressing rib (2-2) is provided on an inner cylinder wall of the slicing knife cylinder (2); and
a dicing knife cylinder (3), wherein the dicing knife cylinder (3) is sheathed in the slicing knife cylinder (2), and the dicing knife cylinder (3) is fixedly connected to the cutting cylinder (1), a dicing knife net (3-2) opposite to the feeding cylinder (1-1) is provided on the cylinder wall of the dicing knife cylinder (3), and a lower port of the feeding cylinder (1-1) is located within the range of an effective net surface of the dicing knife net (3-2), and the dicing knife net (3-2) is formed by cross-combining several first dicing knives (3-2a) and several second dicing knives (3-2b), the knife edge portion of the dicing knives (3-2a) and the knife edge portion of the second dicing knives (3-2b) have a height difference.

2. The drum dicing assembly of claim 1, wherein the first dicing knife (3-2a) is an arc-shaped knife blade provided along the circumference of the dicing knife cylinder (3), the second dicing knife (3-2b) is a straight knife blade provided along the generatrix of the dicing knife cylinder (3), the knife edge portion of the first dicing knife (3-2a) is higher than the knife edge portion of the second dicing knife (3-2b), and the first dicing knife (3-2a) and second dicing knife (3-2b) are both perpendicular to the cutting plane of the slicing knife cylinder (2) located directly below the feeding cylinder (1-1).

3. The drum dicing assembly of claim 1, wherein the dicing knife cylinder (3) has a cylinder body (3-1), the dicing knife net (3-2) is provided on the cylinder body (3-1), and a front end of the cylinder body (3-1) is detachably connected to the cylinder opening of the cutting cylinder (1).

4. The drum dicing assembly of claim 3, wherein the front end of the cylinder body (3-1) of the dicing knife cylinder (3) is provided with a lock catch (3-5), the cylinder opening of the cutting cylinder (1) is provided with a clasp (1-3) at a position corresponding to the above-mentioned lock catch (3-5), and the dicing knife cylinder (3) is detachably fixed together with the clasp (1-3) on the cutting cylinder (1) by the lock catch (3-5).

5. The drum dicing assembly of claim 4, wherein the lock catch (3-5) comprises a push button (3-5-1), a locking piece (3-5-2) and an elastic piece (3-5-3), the locking piece (3-5-2) is movably installed at the front end of the cylinder body (3-1), the push button (3-5-1) is connected to the locking piece (3-5-2), the elastic piece (3-5-3) is provided between the cylinder body (3-1) and the locking piece (3-5-2), so that the locking piece (3-5-2) has an elastic tendency to snap together with the clasp (1-3), the front end of the cylinder (3-1) is further provided with an abutment portion (3-1-1) which abuts against the clasp (1-3).

6. The drum dicing assembly of claim 3, wherein the dicing knife net (3-2) is a knife net assembly detachably installed on the cylinder body (3-1).

7. The drum dicing assembly of claim 1, wherein the shape of a single mesh on the dicing knife net (3-2) is square or rectangular, and the length of a single side of the single mesh is 6 mm to 32 mm.

8. The drum dicing assembly of claim 1, wherein a lower part of the slicing knife (2-1) is provided with a pre-pressing inclined plane (2-1a) along the cutting direction, the material pressing rib (2-2) is provided with 1 to 6 strips at intervals on the inner cylinder wall of the slicing knife cylinder (2), a material pressing height of the material pressing rib (2-2) adjacent to the pre-pressing inclined plane (2-1a) is greater than the material pressing height of the pre-pressing inclined plane (2-1a), and when two or more material pressing ribs (2-2) are provided, the material pressing height of each material pressing rib (2-2) gradually increases from the slicing knife (2-1) backwards along the rotation direction of the slicing knife cylinder (2).

9. The drum dicing assembly of claim 1, wherein the lower part of the slicing knife (2-1) is provided with a pre-pressing inclined plane (2-1a) along the cutting direction, the material pressing height of the material pressing rib (2-2) is greater than the material pressing height of the pre-pressing inclined plane (2-1a), and the material pressing rib (2-2) is closely fitted with an outer side wall of the cylinder body (3-1) of the dicing knife cylinder (3).

10. The drum dicing assembly of claim 8, wherein the material pressing rib (2-2) is a spiral rib spirally provided along the rotation direction of the slicing knife cylinder (2) towards the front discharge port.

11. The drum dicing assembly of claim 9, wherein the material pressing rib (2-2) is a spiral rib spirally provided along the rotation direction of the slicing knife cylinder (2) towards the front discharge port.

12. The drum dicing assembly of claim 1, wherein an inside of the slicing knife cylinder (2) is axially provided with a discharger (2-3) extending into the dicing knife cylinder (3).

13. The drum dicing assembly of claim 12, wherein the discharger (2-3) comprises a cone (2-3a) and several wing plates (2-3b) provided on an outer side wall of the cone (2-3a).

14. The drum dicing assembly of claim 1, wherein the slicing knife cylinder (2) comprises a knife cylinder holder (2A), a slicing knife group (2B) and a material pressing plate (2C), wherein the slicing knife group (2B) and the material pressing plate (2C) are respectively detachably installed on the knife cylinder holder (2A), the slicing knife (2-1) is provided on the slicing knife group (2B), and the material pressing rib (2-2) is provided on the inner side of the material pressing plate (2C).

15. A dicer, comprising a base (5), and further comprising the drum dicing assembly of claims 1, wherein the cutting cylinder (1) is fixed on a base (5), the rear end of the slicing knife cylinder (2) is drivingly connected to a driving mechanism, and a material presser (4) is further provided in the feeding cylinder (1-1).
